(19) United States
(12) Patent Application Publication
(10) Pub. No.: US 2023/0199768 A1
(43) Pub. Date: Jun. 22, 2023

(54) 16QAM TRANSMISSION FOR NBIOT

(71) Applicant: Lenovo (Beijing) Ltd., Beijing (CN)

(72) Inventors: Zhi Yan, Xicheng District (CN); Hongmei Liu, Changping District (CN); Yuantao Zhang, Dongcheng District (CN); Yingying Li, Haidian District (CN); Haiming Wang, Xicheng District (CN)

(73) Assignee: Lenovo (Beijing) Ltd., Beijing (CN)

(21) Appl. No.: 17/791,447

(22) PCT Filed: Sep. 24, 2020
(86) PCT No.: PCT/CN2020/117401

§ 371 Date: Jul. 7, 2022

(30) Foreign Application Priority Data
Jan. 10, 2020 (WO) PCT/CN2020/071469

(51) Int. Cl. H04W 72/20; H04L 1/00; H04L 1/08

(52) U.S. Cl. CPC H04W 72/20; H04L 1/0003; H04L 1/0009; H04L 1/08

(57) ABSTRACT

Methods and apparatuses for transmitting or receiving data for NB-IoT supporting 16QAM modulation are disclosed. A method comprises receiving a control signal, wherein the control signal includes a MCS index, a resource assignment index and a repetition number index; and transmitting or receiving a coded data on a set of subcarrier (s) with a transmission repetition number, wherein the coded data is associated with a modulation type and a transport block size, wherein the transport block size is determined by a combination of a transport block size index and the resource assignment index.

### FIELD

The subject matter disclosed herein generally relates to wireless communications, and more particularly relates to 16QAM transmission for NB-IoT.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal) (UE), Internet-of-Things (IoT), Narrowband (NB), Narrowband Internet-of-Things (NB-IoT or NBIoT), Physical Downlink Shared Channel (PDSCH), Narrowband Physical Downlink Shared Channel (NPDSCH), Downlink Control Information (DCI), Binary Phase Shift Keying (BPSK), Quadrature Phase Shift Keying (QPSK), Quadrature Amplitude Modulation (QAM), transport block size (TBS), modulation and coding scheme (MCS), Physical Uplink Shared Channel (PUSCH), Narrowband Physical Uplink Shared Channel (NPUSCH), Physical Resource Block (PRB).

In NB-IoT Release 16, for NPDSCH, when a coded data is transmitted from the base unit (e.g. gNB) to the remote unit (e.g. UE), the number of resource unit (N_{SF}), the number of repetitions (N_{Rep}) (referred to as “repetition number” hereinafter) and the subcarriers to be used in time and frequency domain for the NPDSCH transmission are determined as follows:

Table 1 indicates the number of resource units (N_{SF}) being determined by resource assignment (I_{SF}). The resource assignment (I_{SF}) is indicated with 3 bits by the corresponding control signal (e.g., DCI format N1). The resource unit for NPDSCH is 1 ms for time domain and 1 PRB (12 subcarriers) in frequency domain.

TABLE 1

| I_{SF} | N_{SF} |
|---|---|
| 0 | 1 |
| 1 | 2 |
| 2 | 3 |
| 3 | 4 |
| 4 | 5 |
| 5 | 6 |
| 6 | 8 |
| 7 | 10 |

The subcarriers to be used for NPDSCH are a total of 12 subcarriers (each subcarrier is 15 KHz).

The coded data is transmitted with a transport block size (TBS), and transmitted by using a modulation type such as QPSK. The modulation type is associated with a modulation order (Qₘ). For example, the modulation order (Qₘ) of QPSK is 2. In the present application, the modulation order (Qₘ) represents the modulation type.

TBS is determined by TBS index (I_{TBS}) and the resource assignment (I_{SF}). TBS index (I_{TBS}) is determined by MCS (modulation and coding scheme) index (I_{MCS}). When QPSK (Qₘ=2) is assumed as the modulation type, I_{TBS}=I_{MCS}. The MCS index (I_{MCS}) is indicated with 4 bits by the corresponding control signal (e.g., DCI format N1).

Table 2 indicates the transport block size (TBS) table in NB-IoT Release 16.

TABLE 2

| | I_{SF} | | | | | | | |
|---|---|---|---|---|---|---|---|---|
| I_{TBS} | 0 | 1 | 2 | 3 | 4 | 5 | 6 | 7 |
| 0 | 16 | 32 | 56 | 88 | 120 | 152 | 208 | 256 |
| 1 | 24 | 56 | 88 | 144 | 176 | 208 | 256 | 344 |
| 2 | 32 | 72 | 144 | 176 | 208 | 256 | 328 | 424 |
| 3 | 40 | 104 | 176 | 208 | 256 | 328 | 440 | 568 |
| 4 | 56 | 120 | 208 | 256 | 328 | 408 | 552 | 680 |
| 5 | 72 | 144 | 224 | 328 | 424 | 504 | 680 | 872 |
| 6 | 88 | 176 | 256 | 392 | 504 | 600 | 808 | 1032 |
| 7 | 104 | 224 | 328 | 472 | 584 | 680 | 968 | 1224 |
| 8 | 120 | 256 | 392 | 536 | 680 | 808 | 1096 | 1352 |
| 9 | 136 | 296 | 456 | 616 | 776 | 936 | 1256 | 1544 |
| 10 | 144 | 328 | 504 | 680 | 872 | 1032 | 1384 | 1736 |
| 11 | 176 | 376 | 584 | 776 | 1000 | 1192 | 1608 | 2024 |
| 12 | 208 | 440 | 680 | 904 | 1128 | 1352 | 1800 | 2280 |
| 13 | 224 | 488 | 744 | 1032 | 1256 | 1544 | 2024 | 2536 |

In Table 2, I_{TBS} ranges from 0 to 13.

The coded data may be configured to be transmitted for a number of times by the repetition number (N_{Rep}). Table 3 indicates the repetition number (N_{Rep}) being determined by repetition number index (I_{Rep}). The repetition number index (I_{Rep}) is indicated with 4 bits by the corresponding control signal (e.g., DCI format N1).

TABLE 3

| I_{Rep} | N_{Rep} |
|---|---|
| 0 | 1 |
| 1 | 2 |
| 2 | 4 |
| 3 | 8 |
| 4 | 16 |
| 5 | 32 |
| 6 | 64 |
| 7 | 128 |
| 8 | 192 |
| 9 | 256 |
| 10 | 384 |
| 11 | 512 |
| 12 | 768 |
| 13 | 1024 |
| 14 | 1536 |
| 15 | 2048 |

In NB-IoT Release 16, for NPUSCH, when a coded data is transmitted from the remote unit (e.g. UE) to the base unit (e.g. gNB), the number of resource unit (N_{RU}) for NPUSCH, the number of repetitions (N_{Rep}) (referred to as “repetition number” hereinafter) for NPUSCH and the subcarriers to be used are determined as follows:

Table 4 indicates the number of resource units (N_{R}U) being determined by the resource assignment (I_{RU}) for NPUSCH. The resource assignment (I_{RU}) is indicated with 3 bits by the corresponding control signal (e.g., DCI format N0). The resource unit for NPUSCH is determined by the subcarrier spacing of the NPUSCH data. For example, for 15 KHz subcarrier spacing, the resource unit of NPUSCH data transmission is 16 slots (8 ms) in time domain and 1 subcarrier in frequency domain, or 8 slots (4 ms) in time domain and 3 subcarriers in frequency domain.

TABLE 4

| I_{RU} | N_{RU} |
|---|---|
| 0 | 1 |
| 1 | 2 |
| 2 | 3 |
| 3 | 4 |
| 4 | 5 |
| 5 | 6 |
| 6 | 8 |
| 7 | 10 |

The subcarriers to be used for NPUSCH data transmission are different for different subcarrier spacings. For subcarrier spacing of 3.75 KHz, only single-tone is supported and one of 48 subcarriers is used within one NBIoT carrier. The used subcarrier can be indicated by a 6-bits Subcarrier indication field in DCI format NO. For subcarrier spacing of 15 KHz, both single-tone and multiple-tone are supported. One or three or six or twelve of twelve subcarriers is used within one NBIoT carrier. The subcarriers to be used are indicated by Subcarrier indication field in Table 5.

TABLE 5

| Subcarrier indication field (I_{SC}) | Set of Allocated subcarrier(s) (N_{SC}) |
|---|---|
| 0-11 | I_{SC} |
| 12-15 | 3 (I_{SC} − 12) + {0, 1, 2} |
| 16-17 | 6 (I_{SC} − 16) + {0, 1, 2, 3, 4, 5} |
| 18 | {0, 1, 2, 3, 4, 5, 6, 7, 8, 9, 10, 11} |
| 19-63 | Reserved |

The transport block size (TBS) for NPUSCH is determined by TBS index (I_{TBS}) and resource assignment (I_{RU}). Table 6 indicates the transport block size (TBS) table for NPUSCH in NB-IoT Release 16. In Table 6, I_{TBS} ranges from 0 to 13.

TABLE 6

| | I_{RU} | | | | | | | |
|---|---|---|---|---|---|---|---|---|
| I_{TBS} | 0 | 1 | 2 | 3 | 4 | 5 | 6 | 7 |
| 0 | 16 | 32 | 56 | 88 | 120 | 152 | 208 | 256 |
| 1 | 24 | 56 | 88 | 144 | 176 | 208 | 256 | 344 |
| 2 | 32 | 72 | 144 | 176 | 208 | 256 | 328 | 424 |
| 3 | 40 | 104 | 176 | 208 | 256 | 328 | 440 | 568 |
| 4 | 56 | 120 | 208 | 256 | 328 | 408 | 552 | 680 |
| 5 | 72 | 144 | 224 | 328 | 424 | 504 | 680 | 872 |
| 6 | 88 | 176 | 256 | 392 | 504 | 600 | 808 | 1000 |
| 7 | 104 | 224 | 328 | 472 | 584 | 712 | 1000 | 1224 |
| 8 | 120 | 256 | 392 | 536 | 680 | 808 | 1096 | 1384 |
| 9 | 136 | 296 | 456 | 616 | 776 | 936 | 1256 | 1544 |
| 10 | 144 | 328 | 504 | 680 | 872 | 1000 | 1384 | 1736 |
| 11 | 176 | 376 | 584 | 776 | 1000 | 1192 | 1608 | 2024 |
| 12 | 208 | 440 | 680 | 1000 | 1128 | 1352 | 1800 | 2280 |
| 13 | 224 | 488 | 744 | 1032 | 1256 | 1544 | 2024 | 2536 |

For single-tone, when N_{sc}^{RU}=1, modulation order (Qₘ) and TBS index (I_{TBS}) are determined by MCS index (I_{MCS}), as shown in Table 6. It can be seen from Table 7 that only BPSK (i.e. Qₘ=1) and QPSK (i.e. Qₘ=2) are supported.

TABLE 7

| MCS Index (I_{MCS}) | Modulation Order (Qₘ) | TBS Index(I_{TBS}) |
|---|---|---|
| 0 | 1 | 0 |
| 1 | 1 | 2 |
| 2 | 2 | 1 |
| 3 | 2 | 3 |
| 4 | 2 | 4 |
| 5 | 2 | 5 |
| 6 | 2 | 6 |
| 7 | 2 | 7 |
| 8 | 2 | 8 |
| 9 | 2 | 9 |
| 10 | 2 | 10 |

For multiple-tone, when N_{sc}^{RU}>1, modulation order (Qₘ)=2 is assumed. In this condition, I_{TBS}=I_{MCS}.

The coded data may be configured to be transmitted for a number of times by the repetition number (N_{Rep}). Table 8 indicates the repetition number (N_{Rep}) being determined by repetition number index (I_{Rep}) for NPUSCH. The repetition number index (I_{Rep}) for NPUSCH is indicated with 3 bits by the corresponding control signal (e.g., DCI format N0).

TABLE 8

| I_{Rep} | N_{Rep} |
|---|---|
| 0 | 1 |
| 1 | 2 |
| 2 | 4 |
| 3 | 8 |
| 4 | 16 |
| 5 | 32 |
| 6 | 64 |
| 7 | 128 |

In the above TBS determination for NB-IoT Release 16, only modulation order (Qₘ)=1 or 2 (i.e. modulation type of BPSK or QPSK) is supported for NPUSCH transmission. In NB-IoT Release 17, modulation type of 16QAM (modulation order (Qₘ)=4) will be supported for uplink and downlink data transmission. In addition, the TBS index (I_{TBS}) for both NPDSCH and NPUSCH may be extended to 21 or 22. The legacy TBS index (I_{TBS}) was indicated by a 4-bits MCS index (I_{MCS}) field, which can NOT directly indicate 22 or 23 different TBS indices. In view of the above, it is necessary to enhance the indication of the modulation order (Qₘ) and the indication of the TBS index (I_{TBS}) by corresponding DCI.

### BRIEF SUMMARY

Methods and apparatuses for transmitting or receiving data for NB-IoT supporting 16QAM modulation are disclosed.

In one embodiment, a method comprises receiving a control signal, wherein the control signal includes a MCS index, a resource assignment index and a repetition number index; and transmitting or receiving a coded data on a set of subcarrier(s) with a transmission repetition number, wherein the coded data is associated with a modulation type and a transport block size, wherein the transport block size is determined by a combination of a transport block size index and the resource assignment index.

In one embodiment, the control signal further includes a subcarrier index. The transport block size index is determined by at least one of the MCS index, the repetition number index, and the subcarrier index. In particular, the transport block size index is determined by the repetition number index and a TBS index offset.

In another embodiment, the transmission repetition number is determined by at least one of the MCS index and the repetition number index. In particular, the transmission repetition number is indicated by value 14 or 15 of the MCS index.

In some embodiment, the MCS index indicates the transport block size or the transmission repetition number. The repetition number index may indicate the transmission repetition number or the transport block size.

In some embodiment, the subcarrier index indicates the modulation type, the set of subcarriers and the transport block size.

In one embodiment, a remote unit comprises a transceiver, the transceiver: receives a control signal, wherein the control signal includes a MCS index, a resource assignment index and a repetition number index; and transmits or receives a coded data on a set of subcarrier(s) with a transmission repetition number, wherein the coded data is associated with a modulation type and a transport block size, wherein the transport block size is determined by a combination of a transport block size index and the resource assignment index.

In another embodiment, a method comprises transmitting a control signal, wherein the control signal includes a MCS index, a resource assignment index and a repetition number index; and receiving or transmitting a coded data on a set of subcarrier(s) with a transmission repetition number, wherein the coded data is associated with a modulation type and a transport block size, wherein the transport block size is determined by a combination of a transport block size index and the resource assignment index.

In yet another embodiment, a base unit comprises a transceiver, the transceiver: transmits a control signal, wherein the control signal includes a MCS index, a resource assignment index and a repetition number index; and receives or transmits a coded data on a set of subcarrier(s) with a transmission repetition number, wherein the coded data is associated with a modulation type and a transport block size, wherein the transport block size is determined by a combination of a transport block size index and the resource assignment index.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 is a schematic flow chart diagram illustrating an embodiment of a method;

FIG. 2 is a schematic flow chart diagram illustrating a further embodiment of a method; and

FIG. 3 is a schematic block diagram illustrating apparatuses according to one embodiment.

### DETAILED DESCRIPTION

As will be appreciated by one skilled in the art that certain aspects of the embodiments may be embodied as a system, apparatus, method, or program product.

Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

The first embodiment is related to the support of 16QAM for NPDSCH of NB-IoT release 17.

According to the first embodiment, the number of resource units (N_{SF}) is determined by the resource assignment (I_{SF}), as indicated in Table 9. Table 9 is the same as Table 1.

TABLE 9

| I_{SF} | N_{SF} |
|---|---|
| 0 | 1 |
| 1 | 2 |
| 2 | 3 |
| 3 | 4 |
| 4 | 5 |
| 5 | 6 |
| 6 | 8 |
| 7 | 10 |

The subcarriers to be used for NPDSCH are a total of 12 subcarriers (one resource unit is 1 ms and 12 subcarrier, each subcarrier is 15 KHz).

The transport block size (TBS) is determined by TBS index (I_{TBS}) and the resource assignment (I_{SF}). The maximal TBS can be increased to two times of legacy value for NPDSCH (e.g., legacy value of NPDSCH TBS is 2536). The maximal TBS index (I_{TBS}) can be extended to 20 or 21. The resource assignment (I_{SF}) (as shown in Table 9) remains as ranging from 0 to 7. Table 10 indicates the transport block size (TBS) table for support of 16QAM, in which I_{TBS} ranges from 0 to 21. If the maximum TBS index (I_{TBS}) is extended to 20, the last line of the Table 10 (i.e. the line with I_{TBS}=21) is omitted.

TABLE 10

| | I_{SF} | | | | | | | |
|---|---|---|---|---|---|---|---|---|
| I_{TBS} | 0 | 1 | 2 | 3 | 4 | 5 | 6 | 7 |
| 0 | 16 | 32 | 56 | 88 | 120 | 152 | 208 | 256 |
| 1 | 24 | 56 | 88 | 144 | 176 | 208 | 256 | 344 |
| 2 | 32 | 72 | 144 | 176 | 208 | 256 | 328 | 424 |
| 3 | 40 | 104 | 176 | 208 | 256 | 328 | 440 | 568 |
| 4 | 56 | 120 | 208 | 256 | 328 | 408 | 552 | 680 |
| 5 | 72 | 144 | 224 | 328 | 424 | 504 | 680 | 872 |
| 6 | 88 | 176 | 256 | 392 | 504 | 600 | 808 | 1000 |
| 7 | 104 | 224 | 328 | 472 | 584 | 712 | 1000 | 1224 |
| 8 | 120 | 256 | 392 | 536 | 680 | 808 | 1096 | 1384 |
| 9 | 136 | 296 | 456 | 616 | 776 | 936 | 1256 | 1544 |
| 10 | 144 | 328 | 504 | 680 | 872 | 1000 | 1384 | 1736 |
| 11 | 176 | 376 | 584 | 776 | 1000 | 1192 | 1608 | 2024 |
| 12 | 208 | 440 | 680 | 1000 | 1128 | 1352 | 1800 | 2280 |
| 13 | 224 | 488 | 744 | 1032 | 1256 | 1544 | 2024 | 2536 |
| 14 | 256 | 552 | 840 | 1128 | 1416 | 1736 | 2280 | 2856 |
| 15 | 280 | 600 | 904 | 1224 | 1544 | 1800 | 2472 | 3112 |
| 16 | 328 | 632 | 968 | 1288 | 1608 | 1928 | 2600 | 3240 |
| 17 | 336 | 696 | 1064 | 1416 | 1800 | 2152 | 2856 | 3624 |
| 18 | 376 | 776 | 1160 | 1544 | 1992 | 2344 | 3112 | 4008 |
| 19 | 408 | 840 | 1288 | 1736 | 2152 | 2600 | 3496 | 4264 |
| 20 | 440 | 904 | 1384 | 1864 | 2344 | 2792 | 3752 | 4584 |
| 21 | 488 | 1000 | 1480 | 1992 | 2472 | 2984 | 4008 | 4968 |

As can be seen from Table 10, legacy TBS table (i.e. I_{TBS} from 0 to 13) is kept for compatibility with Release 16. That is, UE in Release 16 can reuse legacy TBS table (I_{TBS} from 0 to 13) (see Table 2). New entries (i.e. I_{TBS} from 14 to 21) are added for the support of 16QAM (i.e. Qₘ=4).

In NB-IoT release 16, the legacy TBS index (I_{TBS}) is determined (indicated) by 4-bits field MCS index (I_{MCS}). However, 4 bits can only indicate at most 16 values, which is not enough for new TBS index (I_{TBS}) having 22 values (from 0 to 21).

On the other hand, when 16QAM is supported, the channel condition is good. So, there is no need to support large repetition numbers for 16QAM. In NB-IoT release 16, the legacy repetition number (N_{Rep}) is indicated by a 4-bits repetition number index (I_{Rep}) field. When it is only necessary to support small repetition numbers or no repetition (i.e. the repetition number is equal to 1) in 16QAM, some states of the repetition number index (I_{Rep}) field can be used to be joint coded with MCS index (I_{MCS}) field to support 16QAM with extended TBS index.

According to the first embodiment, the 4-bits MCS index (I_{MCS}) field and the 4-bits repetition number index (I_{Rep}) field are joint coded to indicate (1) the modulation order (Qₘ), (2) the TBS index (I_{TBS}), and (3) repetition number (N_{Rep}).

If the MCS index (I_{MCS}) in DCI format N1 is smaller than 14 (I_{MCS}<14), i.e. I_{MCS} is one of 0 to 13, the modulation order (Qₘ) is 2 (i.e. the modulation type is QPSK); otherwise (i.e. the MCS index (I_{MCS}) is 14 or 15), the modulation order (Qₘ) is 4 (i.e. the modulation type is 16QAM).

When the modulation order (Qₘ) is 2 (e.g., I_{MCS}<14), the TBS index (I_{TBS}) is determined by the MCS index (I_{MCS}). For example, the TBS index (I_{TBS}) is equal to the MCS index (I_{MCS}). Table 11 indicates the TBS index (I_{TBS}) table in the condition of modulation order (Qₘ) being equal to 2. When the modulation order (Qₘ) is 2, the range of the TBS index (I_{TBS}) is 0 to 13. So, the range of the TBS index (I_{TBS}) in the condition of modulation order (Qₘ) being equal to 2 is 0 to 13.

TABLE 11

| I_{MCS} | I_{TBS} |
|---|---|
| 0 | 0 |
| 1 | 1 |
| 2 | 2 |
| 3 | 3 |
| 4 | 4 |
| 5 | 5 |
| 6 | 6 |
| 7 | 7 |
| 8 | 8 |
| 9 | 9 |
| 10 | 10 |
| 11 | 11 |
| 12 | 12 |
| 13 | 13 |

When the modulation order (Qₘ) is 2 (e.g., I_{MCS}<14), the repetition number (N_{Rep}) is determined by the repetition number index (I_{Rep}). For example, the repetition number (N_{Rep}) is indicated by the repetition number index (I_{Rep}) as shown in Table 12. Table 12 is the same as Table 3.

TABLE 12

| I_{Rep} | N_{Rep} |
|---|---|
| 0 | 1 |
| 1 | 2 |
| 2 | 4 |
| 3 | 8 |
| 4 | 16 |
| 5 | 32 |
| 6 | 64 |
| 7 | 128 |
| 8 | 192 |
| 9 | 256 |
| 10 | 384 |
| 11 | 512 |
| 12 | 768 |
| 13 | 1024 |
| 14 | 1536 |
| 15 | 2048 |

When the modulation order (Qₘ) is 4 (e.g., I_{MCS} is 14 or 15), the TBS index (I_{TBS}) is determined by the repetition number index (I_{Rep}), while the repetition number (N_{Rep}) is determined by the MCS index (I_{MCS}) or by a combination of the MCS index (I_{MCS}) and the repetition number index (I_{Rep}) in DCI format N1.

Three sub-embodiments are described for determining the TBS index (I_{TBS}) and the repetition number (N_{Rep}) when the modulation order (Qₘ) is 4.

According to a first sub-embodiment, when the MCS index (I_{MCS}) is equal to 14 or 15 (which indicates that the modulation order (Qₘ) is 4), the repetition number (N_{Rep}) is fixed to be 1, i.e. without repetition. Table 13 indicates the repetition number (N_{Rep}) table according to the first sub-embodiment.

TABLE 13

| I_{MCS} | N_{Rep} |
|---|---|
| 14 | 1 |

According to the first sub-embodiment, the TBS index (I_{TBS}) is determined as the repetition number index (I_{Rep}) plus an index offset (ΔI), i.e. I_{TBS}=I_{Rep}+ΔI. For example, the index offset (ΔI) can be fixed as 6. Table 14 indicates the TBS index (I_{TBS}) table in the condition of modulation order (Qₘ) being equal to 4 according to the first sub-embodiment (suppose that ΔI is equal to 6).

TABLE 14

| I_{Rep} | I_{TBS} |
|---|---|
| 0 | 6 |
| 1 | 7 |
| 2 | 8 |
| 3 | 9 |
| 4 | 10 |
| 5 | 11 |
| 6 | 12 |
| 7 | 13 |
| 8 | 14 |
| 9 | 15 |
| 10 | 16 |
| 11 | 17 |
| 12 | 18 |
| 13 | 19 |
| 14 | 20 |
| 15 | 21 |

It can be seen from Table 14 that the range of the TBS index (I_{TBS}) in 16QAM is 6 to 21, while the range of the TBS index (I_{TBS}) in QPSK (see Table 11) is 0 to 13. They may overlap, when the range of the TBS index (I_{TBS}) is 6 to 13; or they may not overlap, when the range of the TBS index (I_{TBS}) is 0 to 5 or 14 to 21.

According to a second sub-embodiment, when the MCS index (I_{MCS}) is equal to 14, the repetition number (N_{Rep}) is 1, i.e. without repetition; when the MCS index (I_{MCS}) is equal to 15, the repetition number (N_{Rep}) is 2. Table 15 indicates the repetition number (N_{Rep}) table according to the second sub-embodiment. Small repetition numbers (e.g. 2 repetition numbers) can be supported by the second sub-embodiment.

TABLE 15

| I_{MCS} | N_{Rep} |
|---|---|
| 14 | 1 |
| 15 | 2 |

When the MCS index (I_{MCS}) is equal to 14 or 15, the TBS index (I_{TBS}) is determined as the repetition number index (I_{Rep}) plus an index offset (ΔI), i.e. I_{TBS}=I_{Rep}+ΔI. For example, the index offset (ΔI) can be fixed as 6. The TBS index (I_{TBS}) table in the condition of modulation order (Qₘ) being equal to 4 (suppose that ΔI is equal to 6) according to the second sub-embodiment is also indicated in Table 14 (the same as the first sub-embodiment).

According to a third sub-embodiment, medium repetition numbers (e.g. 4 repetition numbers) are supported. The repetition number (N_{Rep}) is determined according to the MCS index (I_{MCS}) and one bit (e.g. MSB (most significant bit) or LSB (least significant bit)) of the repetition number index (I_{Rep}). The MCS index (I_{MCS}) for 16QAM can be 14 or 15. The one bit (e.g. MSB or LSB) of the repetition number index (I_{Rep}) can be 0 or 1. So, 4 repetition numbers (e.g. 1, 2, 4 and 8) can be supported according to the third sub-embodiment. Table 16 indicates an example of the repetition number (N_{Rep}) table according to the third sub-embodiment.

TABLE 16

| I_{MCS} | one bit of I_{Rep} | N_{Rep} |
|---|---|---|
| 14 | 0 | 1 |
| 14 | 1 | 2 |
| 15 | 0 | 4 |
| 15 | 1 | 8 |

When the MCS index (I_{MCS}) is equal to 14 or 15, the TBS index (I_{TBS}) is determined as the remaining bits (i.e. the bits except for the one bit used for the indication of the repetition number (N_{Rep})) of repetition number index (I_{Rep}) (referred to as I_{RepL3}) plus an index offset (ΔI), i.e. I_{TBS}=I_{RepL3}+ΔI. For example, if the one bit used for the indication of the repetition number (N_{Rep}) is the MSB of the repetition number index (I_{Rep}), the remaining bits of repetition number index (I_{RepL3}) is the least significant 3 bits of the repetition number index (I_{Rep}). For another example, if the one bit used for the indication of the repetition number (N_{Rep}) is the LSB of the repetition number index (I_{Rep}), the remaining bits of repetition number index (also referred to as I_{RepM3}) is the most significant 3 bits of the repetition number index (I_{Rep}). For example, the index offset (ΔI) can be fixed as 14. Table 17 indicates an example of the TBS index (I_{TBS}) table in the condition of modulation order (Qₘ) being equal to 4 according to the third sub-embodiment (suppose that the remaining bits of repetition number index (I_{RepL3}) is the least significant 3 bits of the repetition number index (I_{Rep}) and that ΔI is equal to 14).

TABLE 17

| I_{Rep} | I_{RepL3} | I_{TBS} |
|---|---|---|
| 0 | 0 | 14 |
| 1 | 1 | 15 |
| 2 | 2 | 16 |
| 3 | 3 | 17 |
| 4 | 4 | 18 |
| 5 | 5 | 19 |
| 6 | 6 | 20 |
| 7 | 7 | 21 |
| 8 | 0 | 14 |
| 9 | 1 | 15 |
| 10 | 2 | 16 |
| 11 | 3 | 17 |
| 12 | 4 | 18 |
| 13 | 5 | 19 |
| 14 | 6 | 20 |
| 15 | 7 | 21 |

It can be seen from Table 17 that the range of the TBS index (I_{TBS}) in 16QAM according to the third sub-embodiment is 14 to 21. That is, there are only 8 entries. On the other hand, according to the first and second sub-embodiments, the TBS index (I_{TBS}) table (i.e. Table 14) has 16 entries.

As a whole, according to the first embodiment for supporting 16QAM (supporting both 16QAM and QPSK) for NPDSCH, the 4-bits MCS index (I_{MCS}) field and the 4-bits repetition number index (I_{Rep}) field are joint coded. The MCS index (I_{MCS}) field is used to indicate QPSK and the TBS index (I_{TBS}) in the condition of QPSK, or indicate 16QAM and the repetition number (N_{Rep}) in the condition of 16QAM. Since the TBS is determined when the TBS index (I_{TBS}) is indicated, the MCS index (I_{MCS}) field indicates the TBS (in QPSK) or the repetition number (N_{Rep}) (in 16QAM). The repetition number index (I_{Rep}) field is used to indicate the repetition number (N_{Rep}) in the condition of QPSK, or indicate the TBS index (I_{TBS}) in the condition of 16QAM. It can be said that the repetition number index (I_{Rep}) field indicates the repetition number (N_{Rep}) (in QPSK) or the TBS (in 16QAM). In addition, the MSB of the repetition number index (I_{Rep}) field can be used in combination with the MCS index (I_{MCS}) field to indicate the repetition number (N_{Rep}) in the condition of 16QAM, while only the remaining least significant bits (except the MSB) of repetition number index (I_{Rep}) field is used to indicate the TBS index (I_{TBS}).

In the first embodiment, the following terms are described: number of resource units (N_{SF}), resource assignment (I_{SF}), repetition number (N_{Rep}), repetition number index (I_{Rep}), transport block size (TBS), transport block size index (TBS index or I_{TBS}), MCS index (I_{MCS}) and modulation order (Qₘ), all of which are used in the context of NPDSCH according to the first embodiment.

The second embodiment is related to the support of 16QAM for NPUSCH of release 17. In the second embodiment, the following terms are used: number of resource units (N_{RU}), resource assignment (I_{RU}), repetition number (N_{Rep}), repetition number index (I_{Rep}), transport block size (TBS), transport block size index (TBS index or I_{TBS}), MCS index (I_{MCS}), modulation order (Qₘ) and subcarrier indication (I_{SC}), all of which are used in the context of NPUSCH according to the second embodiment.

According to the second embodiment, the number of resource units (N_{RU}) is determined by the resource assignment (I_{RU}), as indicated in Table 18. Table 18 is the same as Table 4.

TABLE 18

| I_{RU} | N_{RU} |
|---|---|
| 0 | 1 |
| 1 | 2 |
| 2 | 3 |
| 3 | 4 |
| 4 | 5 |
| 5 | 6 |
| 6 | 8 |
| 7 | 10 |

The transport block size (TBS) is determined by TBS index (I_{TBS}) and the resource assignment (I_{RU}). The maximal TBS remains as in release 16 for NPUSCH. That is, the maximal TBS is 2536. The maximum TBS index (I_{TBS}) may be extended to 20 or 21. The resource assignment (I_{RU}) (as shown in Table 18) remains as ranging from 0 to 7. Table 19 indicates the transport block size (TBS) table for support of 16QAM, in which I_{TBS} ranges from 0 to 21. If the maximum TBS index (I_{TBs}) is extended to 20, the last line of the Table 19 is omitted.

TABLE 19

| | I_{RU} | | | | | | | |
|---|---|---|---|---|---|---|---|---|
| I_{TBS} | 0 | 1 | 2 | 3 | 4 | 5 | 6 | 7 |
| 0 | 16 | 32 | 56 | 88 | 120 | 152 | 208 | 256 |
| 1 | 24 | 56 | 88 | 144 | 176 | 208 | 256 | 344 |
| 2 | 32 | 72 | 144 | 176 | 208 | 256 | 328 | 424 |
| 3 | 40 | 104 | 176 | 208 | 256 | 328 | 440 | 568 |
| 4 | 56 | 120 | 208 | 256 | 328 | 408 | 552 | 680 |
| 5 | 72 | 144 | 224 | 328 | 424 | 504 | 680 | 872 |
| 6 | 88 | 176 | 256 | 392 | 504 | 600 | 808 | 1000 |
| 7 | 104 | 224 | 328 | 472 | 584 | 712 | 1000 | 1224 |
| 8 | 120 | 256 | 392 | 536 | 680 | 808 | 1096 | 1384 |
| 9 | 136 | 296 | 456 | 616 | 776 | 936 | 1256 | 1544 |
| 10 | 144 | 328 | 504 | 680 | 872 | 1000 | 1384 | 1736 |
| 11 | 176 | 376 | 584 | 776 | 1000 | 1192 | 1608 | 2024 |
| 12 | 208 | 440 | 680 | 1000 | 1128 | 1352 | 1800 | 2280 |
| 13 | 224 | 488 | 744 | 1032 | 1256 | 1544 | 2024 | 2536 |
| 14 | 256 | 552 | 840 | 1128 | 1416 | 1736 | 2280 | |
| 15 | 280 | 600 | 904 | 1224 | 1544 | 1800 | 2472 | |
| 16 | 328 | 632 | 968 | 1288 | 1608 | 1928 | | |
| 17 | 336 | 696 | 1064 | 1416 | 1800 | 2152 | | |
| 18 | 376 | 776 | 1160 | 1544 | 1992 | 2344 | | |
| 19 | 408 | 840 | 1288 | 1736 | 2152 | | | |
| 20 | 440 | 904 | 1384 | 1864 | 2344 | | | |
| 21 | 488 | 1000 | 1480 | 1992 | 2472 | | | |

BPSK and/or QPSK are assumed to be used in single-tone for coverage enhancement. On the other hand, T6QAM is supported when the channel condition is good. Therefore, 16QAM is not suitable for single-tone. Similar to the situation of NPDSCH, when the channel condition is good, there is no need to support large repetition numbers for 16QAM.

So, under the assumption that 16QAM is supported due to good channel condition, only small or medium repetition numbers (or without supporting repetition number, i.e. the repetition number is fixed as 1) can be supported. In addition, only multiple tones are supported. In NB-IoT release 16, only QPSK (Qₘ=2) is supported for multiple tones. According to the second embodiment, QPSK and 16QAM are supported for multiple tones.

As shown in Table 5, for the subcarrier indication (I_{SC}) field, only states 0-18 are used while states 19-63 are reserved. According to the second embodiment, the subcarrier indication (I_{SC}) field indicates both the modulation order (Qₘ) and allocated subcarriers for NPUSCH with Δf=15 kHz. Table 20 indicates the modulation order (Qₘ) and allocated subcarriers for NPUSCH with Δf=15 kHz by the subcarrier indication (I_{SC}) field.

TABLE 20

| Subcarrier indication | Modulation | Set of Allocated |
|---|---|---|
| field (I_{SC}) | order Qₘ | subcarrier(s) (N_{SC}) |
| 0-11 | 2 | I_{SC} |
| 12-15 | | 3 (I_{SC} − 12) + {0, 1, 2} |
| 16-17 | | 6 (I_{SC} − 16) + {0, 1, 2, 3, 4, 5} |
| 18 | | {0, 1, 2, 3, 4, 5, 6, 7, 8, 9, 10, 11} |
| 19-22 | 4 | 3(I_{sc} − 19) + {0, 1, 2} |
| 23-24 | | 6(I_{sc} − 23) + {0, 1, 2, 3, 4, 5} |
| 25 | | {0, 1, 2, 3, 4, 5, 6, 7, 8, 9, 10, 11} |
| 26-63 | | Reserved |

As can be seen from Table 20, each subcarrier indication field (I_{SC}) can be used to indicate both the modulation order (Qₘ) and the allocated subcarriers.

In particular, when I_{SC}=0 to 11, the modulation order (Qₘ) is 2 (i.e. QPSK), and the allocated carrier can be calculated by N_{SC}=I_{SC}. For example, when I_{SC}=3, the allocated carrier is #3 (1 tone).

When I_{SC}=12 to 15, the modulation order (Qₘ) is 2 (i.e. QPSK), and the allocated carriers can be calculated by N_{SC}=3 (I_{SC}−12)+{0, 1, 2}. For example, when I_{SC}=13, the allocated carriers are #3, #4 and #5 (3 tones).

When I_{SC}=16 to 17, the modulation order (Qₘ) is 2 (i.e. QPSK), and the allocated carriers can be calculated by N_{SC}=6 (I_{SC}−16)+{0, 1, 2, 3, 4, 5}. For example, when I_{SC}=16, the allocated carriers are #0, #1, #2, #3, #4 and #5 (6 tones).

When I_{SC}=18, the modulation order (Qₘ) is 2 (i.e. QPSK), and the allocated carriers are #0, #1, #2, #3, #4, #5, #6, #7, #8, #9, #10 and #11 (12 tones).

When I_{SC}=19 to 22, the modulation order (Qₘ) is 4 (i.e. 16QAM), and the allocated carriers can be calculated by N_{SC}=3 (I_{SC}−19)+{0, 1, 2}. For example, when I_{SC}=21, the allocated carriers are #6, #7 and #8 (3 tones).

When I_{SC}=23 to 24, the modulation order (Qₘ) is 4 (i.e. 16QAM), and the allocated carriers can be calculated by N_{SC}=6 (I_{SC}−23)+{0, 1, 2, 3, 4, 5}. For example, when I_{SC}=24, the allocated carriers are #6, #7, #8, #9, #10 and #11 (6 tones).

When I_{SC}=25, the modulation order (Qₘ) is 4 (i.e. 16QAM), and the allocated carriers are #0, #1, #2, #3, #4, #5, #6, #7, #8, #9, #10 and #11 (12 tones).

It can be seen that state value of any of 0 to 18 of the subcarrier indication (I_{SC}) field indicates that the modulation order (Qₘ) is 2 (i.e. QPSK), while state value of any of 19 to 25 of the subcarrier indication (I_{SC}) field indicates that the modulation order (Qₘ) is 4 (i.e. 16QAM).

According to the second embodiment, the 4-bits MCS index (I_{MCS}) field and the 3-bits repetition number index (I_{Rep}) field are joint coded to indicate (1) the TBS index (I_{TBS}) and (2) repetition number (N_{Rep}). When the TBS index (I_{TBS}), the TBS is determined. Therefore, it can be said that the 4-bits MCS index (I_{MCS}) field and the 3-bits repetition number index (I_{Rep}) field are joint coded to indicate (1) the TBS and (2) repetition number (N_{Rep}).

When the modulation order (Qₘ) is 2, the TBS index (I_{TBS}) is determined by the MCS index (I_{MCS}). For example, the TBS index (I_{TBS}) is equal to the MCS index (I_{MCS}). Table 21 indicates the TBS index (I_{TBS}) table in the condition of modulation order (Qₘ) being equal to 2. As the range of TBS index for QPSK (Qₘ=2) is 0 to 13, the range of the MCS index (I_{MCS}) for indicating the TBS index (I_{TBS}) for QPSK is also 0 to 13.

TABLE 21

| I_{MCS} | I_{TBS} |
|---|---|
| 0 | 0 |
| 1 | 1 |
| 2 | 2 |
| 3 | 3 |
| 4 | 4 |
| 5 | 5 |
| 6 | 6 |
| 7 | 7 |
| 8 | 8 |
| 9 | 9 |
| 10 | 10 |
| 11 | 11 |
| 12 | 12 |
| 13 | 13 |

When the modulation order (Qₘ) is 2, the repetition number (N_{Rep}) is determined by the repetition number index (I_{Rep}). For example, the repetition number (N_{Rep}) is indicated by the repetition number index (I_{Rep}) as shown in Table 22. Table 22 is the same as Table 8.

TABLE 22

| I_{Rep} | N_{Rep} |
|---|---|
| 0 | 1 |
| 1 | 2 |
| 2 | 4 |
| 3 | 8 |
| 4 | 16 |
| 5 | 32 |
| 6 | 64 |
| 7 | 128 |

When the modulation order (Qₘ) is 4, the TBS index (I_{TBS}) is determined by the MCS index (I_{MCS}) or by a combination of the MCS index (I_{MCS}) and the repetition number index (I_{Rep}), while the repetition number (N_{Rep}) is determined by the MCS index (I_{MCS}) or by a combination of the MCS index (I_{MCS}) and the repetition number index (I_{Rep}).

Two sub-embodiments are described for determining the TBS index (I_{TBS}) and the repetition number (N_{Rep}) when the modulation order (Qₘ) is 4.

According to a fourth sub-embodiment, the TBS index (I_{TBS}) is determined by the MCS index (I_{MCS}), e.g., as the MCS index (I_{MCS}) plus an index offset (ΔI), i.e. I_{TBS}=IM_{CS}+ΔI. For example, the index offset (ΔI) can be fixed as 6. Table 23 indicates the TBS index (I_{TBS}) table in the condition of modulation order (Qₘ) being equal to 4 according to the fourth sub-embodiment (suppose that ΔI is equal to 6).

TABLE 23

| I_{MCS} | I_{TBS} |
|---|---|
| 0 | 6 |
| 1 | 7 |
| 2 | 8 |
| 3 | 9 |
| 4 | 10 |
| 5 | 11 |
| 6 | 12 |
| 7 | 13 |
| 8 | 14 |
| 9 | 15 |
| 10 | 16 |
| 11 | 17 |
| 12 | 18 |
| 13 | 19 |
| 14 | 20 |
| 15 | 21 |

It can be seen from Table 23 that the range of the TBS index (I_{TBS}) in 16QAM is 6 to 21, while the range of the TBS index (I_{TBS}) in QPSK (see Table 21) is 0 to 13. They may overlap, when the range of the TBS index (I_{TBS}) is 6 to 13; or they may not overlap, when the range of the TBS index (I_{TBS}) is 0 to 5 or 14 to 21.

According to the fourth sub-embodiment, the repetition number (N_{Rep}) is determined by the repetition number index (I_{Rep}). For example, the repetition number (N_{Rep}) is indicated by the repetition number index (I_{Rep}) as shown in Table 24. Table 24 is the same as Table 8.

TABLE 24

| I_{Rep} | N_{Rep} |
|---|---|
| 0 | 1 |
| 1 | 2 |
| 2 | 4 |
| 3 | 8 |
| 4 | 16 |
| 5 | 32 |
| 6 | 64 |
| 7 | 128 |

According to a fifth sub-embodiment, the TBS index (I_{TBS}) is determined by a combination of the MCS index (I_{MCS}) and one bit (e.g. MSB or LSB) of the repetition number index (I_{Rep}). The MCS index (I_{MCS}) field is 4 bits and the one bit (e.g. MSB or LSB) of the repetition number index (I_{Rep}) is 1 bit. So, the combination of the MCS index (I_{MCS}) and the one bit of the repetition number index (I_{Rep}) is 5 bits, which can indicate up to 32 states. Therefore, a range of 0 to 21 (22 states) for the TBS index (I_{TBS}) can be indicated by the 5-bits combination of the MCS index (I_{MCS}) and the one bit of the repetition number index (I_{Rep}). Table 25 indicates an example of the TBS index (I_{TBS}) table for NPUSCH in the condition of modulation order (Qₘ) being equal to 4 according to the fifth sub-embodiment. In Table 25, the one bit of the repetition number index (I_{Rep}) is used to indicate the MSB of the TBS index (I_{TBS}), and the MCS index (I_{MCS}) is used to indicate the least significant 4 bits of the TBS index (I_{TBS}).

TABLE 25

| one bit of I_{Rep} | I_{MCS} | I_{TBS} |
|---|---|---|
| 0 | 0 | 0 |
| 0 | 1 | 1 |
| 0 | 2 | 2 |
| 0 | 3 | 3 |
| 0 | 4 | 4 |
| 0 | 5 | 5 |
| 0 | 6 | 6 |
| 0 | 7 | 7 |
| 0 | 8 | 8 |
| 0 | 9 | 9 |
| 0 | 10 | 10 |
| 0 | 11 | 11 |
| 0 | 12 | 12 |
| 0 | 13 | 13 |
| 0 | 14 | 14 |
| 0 | 15 | 15 |
| 1 | 0 | 16 |
| 1 | 1 | 17 |
| 1 | 2 | 18 |
| 1 | 3 | 19 |
| 1 | 4 | 20 |
| 1 | 5 | 21 |
| 1 | 6-15 | unused |

According to the fifth sub-embodiment, the repetition number (N_{Rep}) is determined by the remaining bits (i.e. the bits except for the one bit used for the indication of the TBS index (I_{TBS})) of the repetition number index (I_{Rep}) (referred to as I_{RepL2}). For example, if the one bit used for the indication of the TBS index (I_{TBS}) is the MSB of the repetition number index (I_{Rep}), the remaining bits of repetition number index (I_{RepL2}) is the least significant 2 bits of the repetition number index (I_{Rep}). For another example, if the one bit used for the indication of the TBS index (I_{TBS}) is the LSB of the repetition number index (I_{Rep}), the remaining bits of repetition number index (also referred to as I_{RepM2}) is the most significant 2 bits of the repetition number index (I_{Rep}). Table 26 indicates an example of the repetition number (N_{Rep}) table in the condition of modulation order (Qₘ) being equal to 4 according to the fifth sub-embodiment (suppose that the remaining bits of repetition number index (I_{RepL2}) is the least significant 2 bits of the repetition number index (I_{Rep})).

TABLE 26

| I_{Rep} | I_{RepL2} | N_{Rep} |
|---|---|---|
| 0 | 0 | 1 |
| 1 | 1 | 2 |
| 2 | 2 | 4 |
| 3 | 3 | 8 |
| 4 | 0 | 1 |
| 5 | 1 | 2 |
| 6 | 2 | 4 |
| 7 | 3 | 8 |

According to the second embodiment, the modulation order (Qₘ) is determined by different states of the subcarrier indication (I_{SC}) field; and the MCS index (I_{MCS}) field and the repetition number index (I_{Rep}) field are joint coded to indicate the TBS index (I_{TBS}) and the repetition number (N_{Rep}). In particular, according to the fifth sub-embodiment, the MSB of the repetition number index (I_{Rep}) is used in combination with the MCS index (I_{MCS}) to compose a 5-bits indication to indicate the TBS index (I_{TBS}) so that all of 22 states of the TBS index (I_{TBS}) can be indicated in the condition of 16QAM.

According a sixth sub-embodiment, some states of the subcarrier indication (I_{SC}) field, in place of the MSB of the repetition number index (I_{Rep}), can be used in combination with the MCS index (I_{MCS}) to compose a 5-bits indication to indicate the TBS index (I_{TBS}).

In particular, Table 27 indicates the modulation order (Qₘ) and allocated subcarriers for NPUSCH with Δf=15 kHz by the subcarrier indication (I_{SC}) field.

TABLE 27

| Subcarrier | | | |
|---|---|---|---|
| indication field | Modulation | MSB bit of | Set of Allocated |
| (I_{sc}) | Qₘ | I_{TBS} | subcarriers (n_{sc}) |
| 0-11 | 2 | | I_{sc} |
| 12-15 | | | 3(I_{sc} − 12) + {0, 1, 2} |
| 16-17 | | | 6(I_{sc} − 16) + {3, 1, 2, 3, 4, 5} |
| 18 | | | {0, 1, 2, 3, 4, 5, 6, 7, 8, 9, 10, 11} |
| 19-22 | 4 | 0 | 3(I_{sc} − 19) + {0, 1, 2} |
| 23-24 | | | 6(I_{sc} − 23) + {0, 1, 2, 3, 4, 5} |
| 25 | | | {0, 1, 2, 3, 4, 5, 6, 7, 8, 9, 10, 11} |
| 26-29 | | 1 | 3(I_{sc} − 26) + {0, 1, 2} |
| 30-31 | | | 6(I_{sc} − 30) + {0, 1, 2, 3, 4, 5} |
| 32 | | | {0, 1, 2, 3, 4, 5, 6, 7, 8, 9, 10, 11} |
| 33-63 | | | Reserved |

Table 27 differs from Table 20 in that the states 26-32 of the subcarrier indication field (I_{SC}) are further used to indicate that the modulation order is 4 in addition to the set of allocated subcarriers.

In particular, when I_{SC}=0 to 11, the modulation order (Qₘ) is 2 (i.e. QPSK), and the allocated carrier can be calculated by N_{SC}=I_{SC}. For example, when I_{SC}=3, the allocated carrier is #3 (1 tone).

When I_{SC}=12 to 15, the modulation order (Qₘ) is 2 (i.e. QPSK), and the allocated carriers can be calculated by N_{SC}=3 (I_{SC}−12)+{0, 1, 2}. For example, when I_{SC}=13, the allocated carriers are #3, #4 and #5 (3 tones).

When I_{SC}=16 to 17, the modulation order (Qₘ) is 2 (i.e. QPSK), and the allocated carriers can be calculated by N_{SC}=6 (I_{SC}−16)+{0, 1, 2, 3, 4, 5}. For example, when I_{SC}=16, the allocated carriers are #0, #1, #2, #3, #4 and #5 (6 tones).

When I_{SC}=18, the modulation order (Qₘ) is 2 (i.e. QPSK), and the allocated carriers are #0, #1, #2, #3, #4, #5, #6, #7, #8, #9, #10 and #11 (12 tones).

When I_{SC}=19 to 22, the modulation order (Qₘ) is 4 (i.e. 16QAM), and the allocated carriers can be calculated by N_{SC}=3 (I_{SC}−19)+{0, 1, 2}. For example, when I_{SC}=21, the allocated carriers are #6, #7 and #8 (3 tones).

When I_{SC}=23 to 24, the modulation order (Qₘ) is 4 (i.e. 16QAM), and the allocated carriers can be calculated by N_{SC}=6 (I_{SC}−23)+{0, 1, 2, 3, 4, 5}. For example, when I_{SC}=24, the allocated carriers are #6, #7, #8, #9, #10 and #11 (6 tones).

When I_{SC}=25, the modulation order (Qₘ) is 4 (i.e. 16QAM), and the allocated carriers are #0, #1, #2, #3, #4, #5, #6, #7, #8, #9, #10 and #11 (12 tones).

When I_{SC} is any one of 19 to 25, it can be also used to indicate that the MSB bit of the TBS index (I_{TBS}) is 0.

When I_{SC}=26 to 29, the modulation order (Qₘ) is 4 (i.e. 16QAM), and the allocated carriers can be calculated by N_{SC}=3 (I_{SC}−26)+{0, 1, 2}. For example, when I_{SC}=28, the allocated carriers are #6, #7 and #8 (3 tones).

When I_{SC}=30 to 31, the modulation order (Qₘ) is 4 (i.e. 16QAM), and the allocated carriers can be calculated by N_{SC}=6 (I_{SC}−30)+{0, 1, 2, 3, 4, 5}. For example, when I_{SC}=31, the allocated carriers are #6, #7, #8, #9, #10 and #11 (6 tones).

When I_{SC}=32, the modulation order (Qₘ) is 4 (i.e. 16QAM), and the allocated carriers are #0, #1, #2, #3, #4, #5, #6, #7, #8, #9, #10 and #11 (12 tones).

When I_{SC} is any one of 26 to 31, it can be also used to indicate that the MSB bit of the TBS index (I_{TBS}) is 1.

It can be seen that state value of any of 0 to 18 of the subcarrier indication (I_{SC}) field indicates that the modulation order (Qₘ) is 2 (i.e. QPSK), while state value of any of 19 to 25 of the subcarrier indication (I_{SC}) field indicates that the modulation order (Qₘ) is 4 (i.e. 16QAM) and that the MSB bit of the TBS index (I_{TBS}) is 0; and state value of any of 26 to 32 of the subcarrier indication (I_{SC}) field indicates that the modulation order (Qₘ) is 4 (i.e. 16QAM) and that the MSB bit of the TBS index (I_{TBS}) is 1.

The TBS index (I_{TBS}) is determined by a combination of the MCS index (I_{MCS}) and the states of the subcarrier indication field (I_{SC}) (which is any of 19-25 or any of 26-32). When the state of the subcarrier indication field (I_{SC}) is any of 19-25, the MSB of the TBS index (I_{TBS}) is 0; and when the state of the subcarrier indication field (I_{SC}) is any of 26-32, the MSB of the TBS index (I_{TBS}) is 1. The MCS index (I_{MCS}) field, which is 4 bits, is used to indicate the least significant 4 bits of the TBS index (I_{TBS}). Therefore, a range of 0 to 21 (22 states) for the TBS index (I_{TBS}) can be indicated by the 5-bits combination of 1-bit indication by the subcarrier indication field (I_{SC}) and 4-bits of the MCS index (I_{MCS}). Table 28 indicates an example of the TBS index (I_{TBS}) table in the condition of modulation order (Qₘ) being equal to 4 according to the sixth sub-embodiment.

TABLE 28

| Subcarrier indication field (I_{sc}) | I_{MCS} | I_{TBS} |
|---|---|---|
| any of 19-25 | 0 | 0 |
| any of 19-25 | 1 | 1 |
| any of 19-25 | 2 | 2 |
| any of 19-25 | 3 | 3 |
| any of 19-25 | 4 | 4 |
| any of 19-25 | 5 | 5 |
| any of 19-25 | 6 | 6 |
| any of 19-25 | 7 | 7 |
| any of 19-25 | 8 | 8 |
| any of 19-25 | 9 | 9 |
| any of 19-25 | 10 | 10 |
| any of 19-25 | 11 | 11 |
| any of 19-25 | 12 | 12 |
| any of 19-25 | 13 | 13 |
| any of 19-25 | 14 | 14 |
| any of 19-25 | 15 | 15 |
| any of 28-32 | 0 | 16 |
| any of 26-32 | 1 | 17 |
| any of 26-32 | 2 | 18 |
| any of 26-32 | 3 | 19 |
| any of 26-32 | 4 | 20 |
| any of 26-32 | 5 | 21 |
| any of 26-32 | 6-15 | unused |

According to the sixth sub-embodiment, when the TBS index (I_{TBS}) is determined by a combination of the MCS index (I_{MCS}) and the states of the subcarrier indication field (I_{SC}), the repetition number (N_{Rep}) is determined by the repetition number index (I_{Rep}). Table 29 indicates the repetition number (N_{Rep}) table for NPUSCH in the condition of modulation order (Qₘ) being equal to 4 according to the sixth sub-embodiment.

TABLE 29

| I_{Rep} | N_{Rep} |
|---|---|
| 0 | 1 |
| 1 | 2 |
| 2 | 4 |
| 3 | 8 |
| 4 | 16 |
| 5 | 32 |
| 6 | 64 |
| 7 | 128 |

As a whole, according to the second embodiment for supporting 16QAM (supporting both 16QAM and QPSK) for NPUSCH, the modulation type (i.e. the modulation order (Qₘ)) can be indicated together with the set of allocated subcarriers by the subcarrier indication (I_{SC}) field. The MCS index (I_{MCS}) and the repetition number index (I_{Rep}) can be jointed coded to indicate the TBS index (I_{TBS}) (accordingly indicating the TBS) and the repetition number (N_{Rep}). If 5 bits are necessary to indicate all of 22 states of the TBS index (I_{TBS}), in addition to the 4-bits MCS index (I_{MCS}), the extra one bit can be indicated by the MSB of the repetition number index (I_{Rep}) or states of the subcarrier indication field (I_{SC}). Therefore, the subcarrier indication field (I_{SC}) can be used to indicate the modulation type (i.e. the modulation order (Qₘ)), the set of subcarriers and the transport block size (i.e. the TBS index (I_{TBS})).

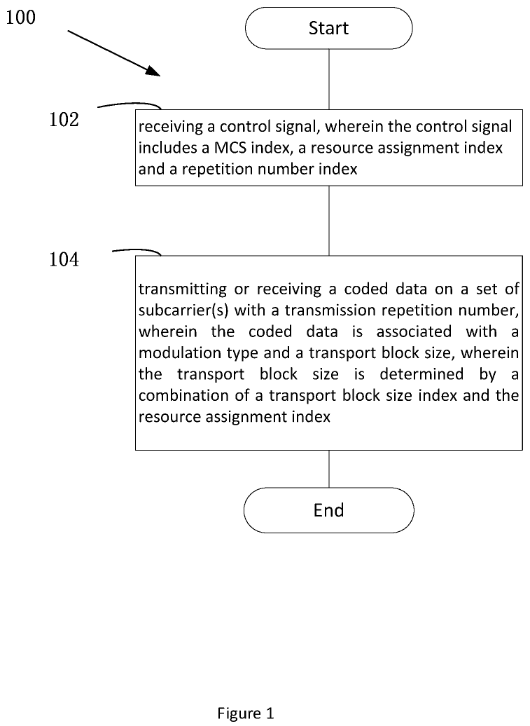

FIG. 1 is a schematic flow chart diagram illustrating an embodiment of a method 100 according to the present application. In some embodiments, the method 100 is performed by an apparatus, such as a remote unit. In certain embodiments, the method 100 may be performed by a processor executing program code, for example, a microcontroller, a microprocessor, a CPU, a GPU, an auxiliary processing unit, a FPGA, or the like.

The method 100 may include 102 receiving a control signal, wherein the control signal includes a MCS index, a resource assignment index and a repetition number index; and 104 transmitting or receiving a coded data on a set of subcarrier(s) with a transmission repetition number, wherein the coded data is associated with a modulation type and a transport block size, wherein the transport block size is determined by a combination of a transport block size index and the resource assignment index.

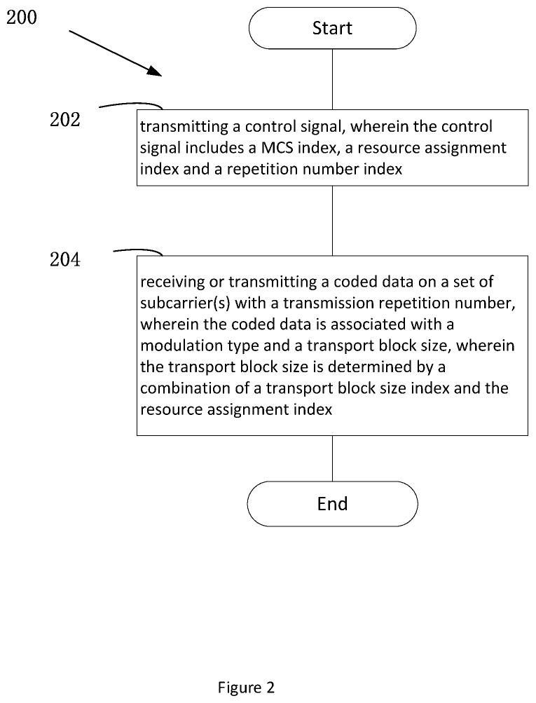

FIG. 2 is a schematic flow chart diagram illustrating a further embodiment of a method 200 according to the present application. In some embodiments, the method 200 is performed by an apparatus, such as a base unit. In certain embodiments, the method 200 may be performed by a processor executing program code, for example, a microcontroller, a microprocessor, a CPU, a GPU, an auxiliary processing unit, a FPGA, or the like.

The method 200 may include 202 transmitting a control signal, wherein the control signal includes a MCS index, a resource assignment index and a repetition number index; and 204 receiving or transmitting a coded data on a set of subcarrier(s) with a transmission repetition number, wherein the coded data is associated with a modulation type and a transport block size, wherein the transport block size is determined by a combination of a transport block size index and the resource assignment index.

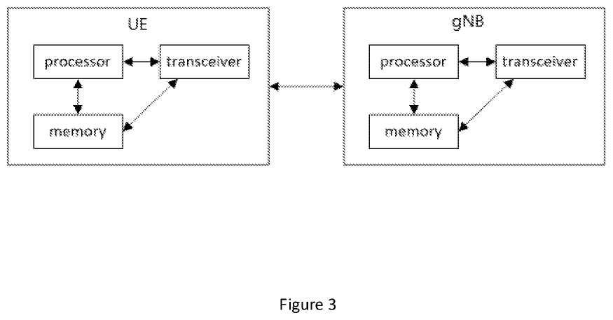

FIG. 3 is a schematic block diagram illustrating apparatuses according to one embodiment.

Referring to FIG. 3, the UE (i.e. the remote unit) includes a processor, a memory, and a transceiver. The processor implements a function, a process, and/or a method which are proposed in FIG. 1. The eNB (i.e. base unit) includes a processor, a memory, and a transceiver. The processors implement a function, a process, and/or a method which are proposed in FIG. 2. Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A method, comprising:
receiving a control signal, the control signal includes a modulation and coding scheme (MCS) index, a resource assignment index, and a repetition number index; and
transmitting or receiving a coded data on a set of one or more subcarriers with a transmission repetition number, the coded data is associated with a modulation type and a transport block size, the transport block size is determined by a combination of a transport block size index and the resource assignment index.

2. The method of claim 1, wherein, the control signal further includes a subcarrier index.

3. The method of claim 2, wherein, the transport block size index is determined by at least one of the MCS index, the repetition number index, or the subcarrier index.

4. The method of claim 3, wherein, the transport block size index is determined by the repetition number index and a transport block size index offset.

5. The method of claim 1, wherein, the transmission repetition number is determined by at least one of the MCS index or the repetition number index.

6. (canceled)

7. The method of claim 1, wherein, the MCS index indicates the transport block size or the transmission repetition number.

8. The method of claim 1, wherein, the repetition number index indicates the transmission repetition number or the transport block size.

9. (canceled)

10. An apparatus, comprising:
a transceiver; and
a processor coupled with the transceiver, the processor and the transceiver configured to:
receive a control signal, the control signal includes a modulation and coding scheme (MCS) index, a resource assignment index, and a repetition number index; and
transmit or receive a coded data on a set of one or more subcarriers with a transmission repetition number, the coded data is associated with a modulation type and a transport block size, the transport block size is determined by a combination of a transport block size index and the resource assignment index.

11. The apparatus of claim 10, wherein, the control signal further includes a subcarrier index.

12. The apparatus of claim 11, wherein, the transport block size index is determined by at least one of the MCS index, the repetition number index, or the subcarrier index.

13. The apparatus of claim 12, wherein, the transport block size index is determined by the repetition number index and a transport block size index offset.

14. The apparatus of claim 10, wherein, the transmission repetition number is determined by at least one of the MCS index or the repetition number index.

15. (canceled)

16. The apparatus of claim 10, wherein, the MCS index indicates the transport block size or the transmission repetition number.

17. The apparatus of claim 10, wherein, the repetition number index indicates the transmission repetition number or the transport block size.

18. The apparatus of claim 11, wherein, the subcarrier index indicates the modulation type, the set of the one or more subcarriers, and the transport block size.

19-27. (canceled)

28. An apparatus, comprising:
a transceiver; and
a processor coupled with the transceiver, the processor and the transceiver configured to:
transmit a control signal, the control signal includes a modulation and coding scheme (MCS) index, a resource assignment index, and a repetition number index; and
receive or transmit a coded data on a set of one or more subcarriers with a transmission repetition number, the coded data is associated with a modulation type and a transport block size, the transport block size is determined by a combination of a transport block size index and the resource assignment index.

29. The apparatus of claim 28, wherein, the control signal further includes a subcarrier index.

30. The apparatus of claim 29, wherein, the transport block size index is determined by at least one of the MCS index, the repetition number index, or the subcarrier index.

31. The apparatus of claim 30, wherein, the transport block size index is determined by the repetition number index and a transport block size index offset.

32. The apparatus of claim 28, wherein, the transmission repetition number is determined by at least one of the MCS index or the repetition number index.

33-36. (canceled)
